(19) United States
(12) Patent Application Publication
(10) Pub. No.: US 2014/0047735 A1
(43) Pub. Date: Feb. 20, 2014

(54) Cleaning Apparatus for Glass Substrate

(71) Applicants: Weibing Yang, Shenzhen (CN); Chunhao Wu, Shenzhen (CN); Kunhsien Lin, Shenzhen (CN); Yongqiang Wang, Shenzhen (CN); Zhiyou Shu, Shenzhen (CN); Xiande Li, Shenzhen (CN); Minghu Qi, Shenzhen (CN); Zenghong Chen, Shenzhen (CN); Zhenhua Guo, Shenzhen (CN); Yunshao Jiang, Shenzhen (CN)

(72) Inventors: Weibing Yang, Shenzhen (CN); Chunhao Wu, Shenzhen (CN); Kunhsien Lin, Shenzhen (CN); Yongqiang Wang, Shenzhen (CN); Zhiyou Shu, Shenzhen (CN); Xiande Li, Shenzhen (CN); Minghu Qi, Shenzhen (CN); Zenghong Chen, Shenzhen (CN); Zhenhua Guo, Shenzhen (CN); Yunshao Jiang, Shenzhen (CN)

(73) Assignee: SHENZHEN CHINA STAR OPTOELECTRONICS TECHNOLOGY CO. LTD., Shenzhen (CN)

(21) Appl. No.: 13/641,101

(22) PCT Filed: Aug. 17, 2012
(86) PCT No.: PCT/CN12/80290

§ 371 Date: Oct. 13, 2012

(30) Foreign Application Priority Data
Aug. 14, 2012 (CN) 201210288683.6

(51) Int. Cl. F26B 21/00

(52) U.S. Cl. CPC F26B 21/004
USPC 34/611

(57) ABSTRACT

The present invention discloses a cleaning apparatus for glass substrate, and which includes an air knife and a conveying device. The air knife is used to dry the glass substrate. The conveying device includes a primary roller set for carrying and advancing the glass substrate, and an auxiliary roller set which is arranged before the air knife and above the primary roller set. The glass substrate is fed and advanced jointly by the operation of the primary roller set and the auxiliary roller set. By this arrangement, the damage rate of the glass substrate can be lowered, while the yield of the glass substrate can be increased.

### FIELD OF THE INVENTION

The present invention relates to a technical field of making liquid crystal display device, and more particularly to a cleaning apparatus for glass substrate.

### DESCRIPTION OF PRIOR ART

Before the glass substrate for use with a liquid crystal display device in final production has undergone a complete and thorough bath, or cleaning process. Please referring to FIG. 1 which is an illustrational and structural view of a washing apparatus used in the prior art. As shown, the prior art washing apparatus 10 includes a air knife 101, a plurality of transaxles 102, and a plurality of rollers 103 installed on the transaxles 102. The air knife 101 includes an upper nozzle 111 and a lower nozzle 112. The rollers 103 are used to support the glass substrate 20 and advance the glass substrate 20 to pass through the upper and lower nozzles 111, 112 of the air knife 101.

Currently, the glass substrate becomes thinner and thinner, i.e. it becomes lighter and lighter. Accordingly, once the glass substrate 20 is exposed to the compressed air or cleaning liquid or agent, the glass substrate 20 will float about over the rollers 103. Furthermore, when the glass substrate 20 reaches to the bower 101, there is a certain differential and gradient between the upper and lower nozzles 111, 112 in view of their pressure, velocity as well as stability. As a result, the glass substrate 20 tends to create a vibration when it reaches to the air knife 101. Once the glass substrate 20 starts to vibrate, it creates another turbulence that intensify the vibration of the glass substrate 20. Furthermore, once the vibration of the glass substrate 20 exceed a limit of a gap between the upper and lower nozzles 111 and 112, the glass substrate 20 will be damaged once it hits to the nozzles 111, 112. In case this happens, then the whole production line will be shut down to field investigation, diagnosis and adjustment, cleaning, pilot run etc. The whole recover process will take about at least two to three hours. As a result, not only the yield will be lowered, the manufacturing cost is also increased inevitably.

### SUMMARY OF THE INVENTION

It is an object to provide a cleaning apparatus to resolve the technical issue encountered by the prior art so as to effectively reduce the damage rate of the glass substrate, while increases the yield and also lowering the manufacturing cost.

In order to resolve the technical issue encountered by the prior art, the present invention provides a technical solution by introducing a cleaning apparatus which comprises an air knife for drying a glass substrate. A conveying device includes a primary roller set for conveying the glass substrate, wherein the conveying device further includes an auxiliary roller set located above the primary roller set and before the air knife, wherein the primary roller set and the auxiliary roller set jointly operated for advancing the glass substrate toward the air knife. Wherein the auxiliary roller set is distant to the air knife between 400 mm to 20 mm; and wherein the air knife includes an upper nozzle and a lower nozzle which a vertical gap therebetween substantial larger or equal to a vertical distance between the auxiliary roller set and the primary roller set.

Wherein the primary roller set and the auxiliary roller set each includes a plurality of transaxles arranged in parallel to each other, and each of the transaxles is incorporated with a plurality of rollers.

Wherein both the front and rear of the air knife is provided with the primary auxiliary roller set, the primary roller set located before the air knife includes a first roller set, and a second roller set, wherein the first roller set is located right under the auxiliary roller set, and the second roller set is distant to the air knife than the first roller set, wherein a pitch between every two adjacent transaxles of the first roller set is D1, and a pitch between every two adjacent transaxles of the second roller set is D2, wherein D1 is smaller than D2.

Wherein a pitch between every two adjacent transaxles of the auxiliary roller set is D3, and wherein D3 equals to D1.

Wherein D1 equals to two third of D2.

Wherein D1 equals to 80 mm, and D2 equals to 120 mm

Wherein the transaxles of the auxiliary roller set and the transaxles of the primary roller set are alternatively arranged along the horizontal direction.

Wherein any one of the transaxles of the auxiliary roller set constructs a triangle with respect to two corresponding two of the transaxles of the primary roller set, wherein any internal angle of the triangle is less than ninety (90) degrees.

Wherein the cleaning apparatus further includes a pair of fenders arranged on sides of the transaxles.

In order to resolve the technical issue encountered by the prior art, the present invention provides a technical solution by introducing a cleaning apparatus which comprises an air knife for drying a glass substrate. A conveying device includes a primary roller set for conveying the glass substrate, wherein the conveying device further includes an auxiliary roller set located above the primary roller set and before the air knife, wherein the primary roller set and the auxiliary roller set jointly operated for advancing the glass substrate toward the air knife.

Wherein the auxiliary roller set is distant to the air knife between 400 mm to 20 mm

Wherein the primary roller set and the auxiliary roller set each includes a plurality of transaxles arranged in parallel to each other, and each of the transaxles is incorporated with a plurality of rollers.

Wherein both the front and rear of the air knife is provided with the primary auxiliary roller set, the primary roller set located before the air knife includes a first roller set, and a second roller set, wherein the first roller set is located right under the auxiliary roller set, and the second roller set is distant to the air knife than the first roller set, wherein a pitch between every two adjacent transaxles of the first roller set is D1, and a pitch between every two adjacent transaxles of the second roller set is D2, wherein D1 is smaller than D2.

Wherein a pitch between every two adjacent transaxles of the auxiliary roller set is D3, and wherein D3 equals to D1.

Wherein D1 equals to two third of D2.

Wherein D1 equals to 80 mm, and D2 equals to 120 mm

Wherein the transaxles of the auxiliary roller set and the transaxles of the primary roller set are alternatively arranged along the horizontal direction.

Wherein any one of the transaxles of the auxiliary roller set constructs a triangle with respect to two corresponding two of the transaxles of the primary roller set, wherein any internal angle of the triangle is less than ninety (90) degrees.

Wherein the air knife includes an upper nozzle and a lower nozzle which a vertical gap therebetween substantial larger or equal to a vertical distance between the auxiliary roller set and the primary roller set.

Wherein the cleaning apparatus further includes a pair of fenders arranged on sides of the transaxles.

The present invention can be concluded with the following advantages. As compared to the prior art, the cleaning apparatus made in accordance with the present invention is arranged with a primary roller set and an auxiliary roller set right in front of the air knife such that a glass substrate can be readily and firmly held and advanced through an upper and lower nozzles without vibration with the synchronically advancement of the primary roller set and the auxiliary roller set. Accordingly, as the glass substrate is firmly held and advanced by the primary roller set and the auxiliary set, any fluctuation on pressure as well as velocity of the compressed air from the air knife will not significantly affect the glass substrate for no major vibration to the glass substrate can be created as it is firmly held. As the vibration is limited to a controlled tolerance and small, the glass substrate can be effectively prevented from bumping into the air knife. Accordingly, no damage to the glass substrate will be encountered. In addition, since the glass substrate is firmly held, the cleaning process can be effectively done, and the cleaning result is significant increased.

### BRIEF DESCRIPTION OF DRAWINGS

FIG. 1 is an illustrational and structural view of a prior art washing apparatus;

FIG. 2 is an illustrational and structural view of a cleaning apparatus made in accordance with the present invention; and

FIG. 3 is an illustrational sketch showing an arrangement of an auxiliary roller set and a first roller set incorporated in the cleaning apparatus shown in FIG. 2.

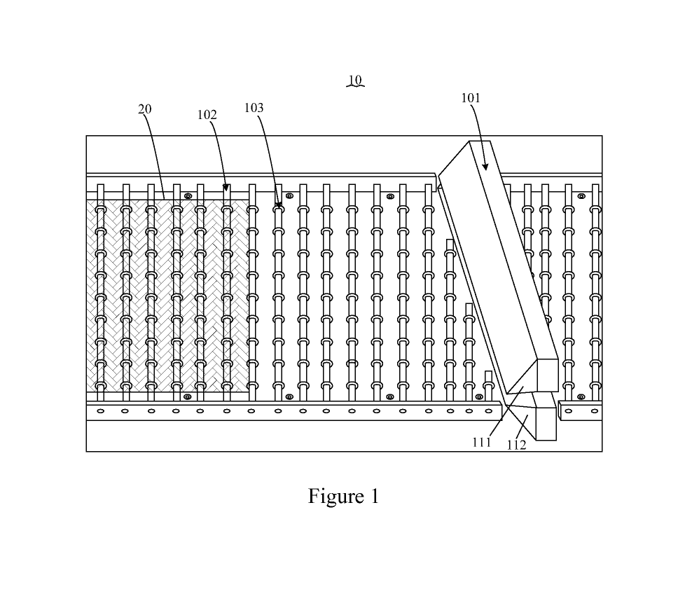

### DETAILED DESCRIPTION OF PREFERRED EMBODIMENT

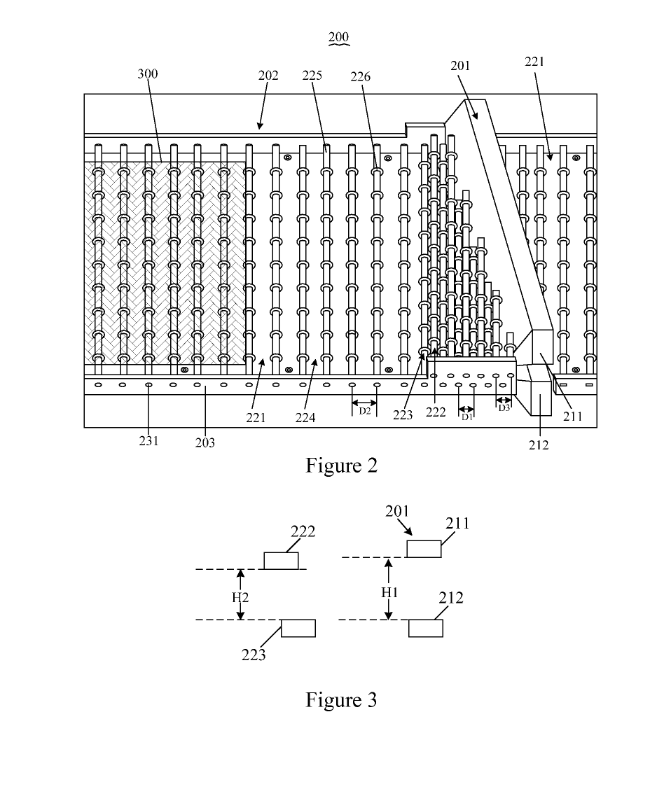

Referring to FIG. 2, an illustrational and structural view of a cleaning apparatus made in accordance with the present invention. As shown, the cleaning apparatus 200 made in accordance with the present invention includes an air knife 1201 and a conveying device 202.

The air knife 201 is driven by compressed air creating a blowing curtain of air flow so as to dry up the glass substrate 300.

In the current embodiment, the air knife 201 is made from aluminum alloy or stainless steel.

The conveying device 202 includes a primary roller set 221 and an auxiliary roller set 222 arranged on upper and lower side of a glass substrate 300. The primary roller set 221 is used to carry the glass substrate 300. There is totally two primary roller sets 221 and one arranged in front of the air knife 201, and the other is arranged on the rear side of the air knife 210. The auxiliary roller set 222 is arranged also in front of the air knife 201 and also above the primary roller set 221. Preferably, the auxiliary roller set 222 is distant to the air knife 201 between 400 mm to 20 mm By this arrangement, the glass substrate 300 is held firmly by both the primary roller set 221 and the auxiliary roller set 222 advancing toward the air knife 201.

Substantially, the primary roller set 221 which is located in front of the air knife 201 includes a first roller set 223 and a second roller set 224. Wherein the first roller set 223 is located right under the auxiliary roller set 222, and the second roller set 224 is distant to the air knife 201, while is adjacent to the first roller set 223.

In the present embodiment, the primary roller set 221 and the auxiliary roller set 222 each includes a plurality of transaxles 225 arranged in parallel to each other, and each of the transaxles 225 is provided with a plurality of rollers 226. The rollers 226 are used to support the glass substrate 300. When the rollers 226 are rotated by the transaxles 225, the glass substrate thereon is advanced.

In the present embodiment, the pitch between two adjacent transaxles 225 of the first roller set 223 is D1, the pitch between two adjacent transaxles 225 of the second roller set 224 is D2, and the pitch between two adjacent transaxles 225 of the auxiliary roller set 223 is D3. In order to stabilize the glass substrate 300, the present provide a multiple supporting points to the glass substrate 300. The pitch D1 of the two adjacent transaxles 225 of the first roller set 223 is smaller than the pitch D2 between two adjacent transaxles 225 of the second roller set 224. As a result, this arrangement will increase the density of the transaxles 225. In turn, the rollers 226 are increased as well. By this arrangement, the more closer to the air knife 201, the more dense of the rollers 226 thereof. Accordingly, the glass substrate 300 gets more support on the area right before the air knife 201 and which is the more critical area in view of the fluctuation of the compressed air. It can be readily understood that the pitch D3 between the transaxles 225 of the auxiliary roller set 222 equals to the pitch D1 between the transaxles 225 of the first roller set 223. As a result, this provides an excellent stability to the glass substrate 300.

In the current embodiment, D1 and D3 equal to two third of the D2. Preferably, D1 and D3 equal to 80 mm, while D2 equals to 120 mm

Furthermore, the transaxles 225 of the auxiliary roller set 222 and the transaxles 225 of the primary roller set 221 are alternatively arranged along a horizontal direction. In the current embodiment, the transaxles 225 of the auxiliary roller set 222 is alternatively arranged with respect to the transaxles 225 of the first roller set 223 along the horizontal direction. Substantially, the transaxle 225 of the auxiliary roller set 222 is arranged on a middle line between the transaxles 225 of the first roller set 223. By this arrangement, the glass substrate 300 can be readily and evenly held by the auxiliary roller set 222 and the first roller set 223. In turn, this will increase the stability of the glass substrate 300 when it is advanced.

In the current embodiment, in the front of the air knife 201, the arrangement of the auxiliary roller set 222 and the first roller set 223 around the glass substrate 300 is shown in FIG. 3. Wherein the air knife 201 includes an upper nozzle 211 and a lower nozzle 212. A gap H1 between the upper and lower nozzles 211 and 212 equal to the gap H2 between the auxiliary roller set 222 and the first roller set 223. Accordingly, the gap H2 is slightly larger than a thickness of the glass substrate 300.

In the current embodiment, the cleaning apparatus 200 further includes a pair of fenders 203 attached to ends of the transaxles 225. Substantially, the fender 203 is defined with a plurality of openings 231 corresponding to the ends of the transaxles 225 such that the transaxles 225 can be readily secured therein.

As described above, the glass substrate 300 can be readily advanced by the operation of the auxiliary roller set 222 and the primary roller set 221. In addition, since the vibration before the air knife 201 is limited to a certain range, the glass substrate 300 can smoothly pass through the air knife 201 without any damage thereto. The actual procedures will be described as below.

Firstly, the second roller set 224 will support the glass substrate 300 and advance the glass substrate 300 toward the air knife 201 with the help of the rollers 226. When the glass substrate 300 reaches to the front court of the air knife 201, the glass substrate 300 will be fed into the gap between the auxiliary roller set 222 and the first roller set 223 to move further toward the air knife 201. Meanwhile, since there is a certain difference between the pressure, velocity and stability between the upper nozzle 211 and the lower nozzle 212, the glass substrate 30 may easily encounter a vibration. However, in the present invention, the glass substrate 300 is fed and held by the auxiliary roller set 222 and the first roller set 223, as a result, the vibration of the glass substrate 300 is controlled within a certain range. In addition, the vertical gap H1 between the upper nozzle 221 and the lower nozzle 212 equals or is slightly larger then the gap H2 between the auxiliary roller set 22 and the first roller set 223, accordingly, the glass substrate 300 will not bump into the air knife 201. In addition, since the range of the vibration is controlled in a narrowed range, the cleaning agent within the cleaning apparatus 200 may have a comparably large surface contact with respect to the glass substrate 300. A better cleaning result can be reached.

The present invention is arranged with a primary roller set and an auxiliary roller set right in front of the air knife such that a glass substrate can be readily and firmly held and advanced through an upper and lower nozzles without vibration with the synchronically advancement of the primary roller set and the auxiliary roller set. Accordingly, as the glass substrate is firmly held and advanced by the primary roller set and the auxiliary set, any fluctuation on pressure as well as velocity of the compressed air from the air knife will not significantly affect the glass substrate for no major vibration to the glass substrate can be created as it is firmly held. As the vibration is limited to a controlled tolerance and small, the glass substrate can be effectively prevented from bumping into the air knife. Accordingly, no damage to the glass substrate will be encountered. In addition, since the glass substrate is firmly held, the cleaning process can be effectively done, and the cleaning result is significant increased.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

1. A cleaning apparatus, comprising:
an air knife for drying a glass substrate;
a conveying device including a primary roller set for conveying the glass substrate, wherein
the conveying device further includes an auxiliary roller set located above the primary roller set and before the air knife, wherein the primary roller set and the auxiliary roller set jointly operated for advancing the glass substrate toward the air knife;
wherein the auxiliary roller set is distant to the air knife between 400 mm to 20 mm; and
wherein the air knife includes an upper nozzle and a lower nozzle which a vertical gap therebetween substantial larger or equal to a vertical distance between the auxiliary roller set and the primary roller set.

2. The cleaning apparatus as recited in claim 1, wherein the primary roller set and the auxiliary roller set each includes a plurality of transaxles arranged in parallel to each other, and each of the transaxles is incorporated with a plurality of rollers.

3. The cleaning apparatus as recited in claim 2, wherein both the front and rear of the air knife is provided with the primary auxiliary roller set, the primary roller set located before the air knife includes a first roller set, and a second roller set, wherein the first roller set is located right under the auxiliary roller set, and the second roller set is distant to the air knife than the first roller set, wherein a pitch between every two adjacent transaxles of the first roller set is D1, and a pitch between every two adjacent transaxles of the second roller set is D2, wherein D1 is smaller than D2.

4. The cleaning apparatus as recited in claim 3, wherein a pitch between every two adjacent transaxles of the auxiliary roller set is D3, and wherein D3 equals to D1.

5. The cleaning apparatus as recited in claim 3, wherein D1 equals to two third of D2.

6. The cleaning apparatus as recited in claim 5, wherein D1 equals to 80 mm, and D2 equals to 120 mm.

7. The cleaning apparatus as recited in claim 2, wherein the transaxles of the auxiliary roller set and the transaxles of the primary roller set are alternatively arranged along the horizontal direction.

8. The cleaning apparatus as recited in claim 7, wherein any one of the transaxles of the auxiliary roller set constructs a triangle with respect to two corresponding two of the transaxles of the primary roller set, wherein any internal angle of the triangle is less than ninety (90) degrees.

9. The cleaning apparatus as recited in claim 1, wherein the cleaning apparatus further includes a pair of fenders arranged on sides of the transaxles.

10. A cleaning apparatus, comprising:
an air knife for drying a glass substrate;
a conveying device including a primary roller set for conveying the glass substrate, and wherein
the conveying device further includes an auxiliary roller set located above the primary roller set and before the air knife, wherein the primary roller set and the auxiliary roller set jointly operated for advancing the glass substrate toward the air knife.

11. The cleaning apparatus as recited in claim 10, wherein the auxiliary roller set is distant to the air knife between 400 mm to 20 mm.

12. The cleaning apparatus as recited in claim 10, wherein the primary roller set and the auxiliary roller set each includes a plurality of transaxles arranged in parallel to each other, and each of the transaxles is incorporated with a plurality of rollers.

13. The cleaning apparatus as recited in claim 12, wherein both the front and rear of the air knife is provided with the primary auxiliary roller set, the primary roller set located before the air knife includes a first roller set, and a second roller set, wherein the first roller set is located right under the auxiliary roller set, and the second roller set is distant to the air knife than the first roller set, wherein a pitch between every two adjacent transaxles of the first roller set is D1, and a pitch between every two adjacent transaxles of the second roller set is D2, wherein D1 is smaller than D2.

14. The cleaning apparatus as recited in claim 13, wherein a pitch between every two adjacent transaxles of the auxiliary roller set is D3, and wherein D3 equals to D1.

15. The cleaning apparatus as recited in claim 13, wherein D1 equals to two third of D2.

16. The cleaning apparatus as recited in claim 15, wherein D1 equals to 80 mm, and D2 equals to 120 mm.

17. The cleaning apparatus as recited in claim 12, wherein the transaxles of the auxiliary roller set and the transaxles of the primary roller set are alternatively arranged along the horizontal direction.

18. The cleaning apparatus as recited in claim 17, wherein any one of the transaxles of the auxiliary roller set constructs a triangle with respect to two corresponding two of the transaxles of the primary roller set, wherein any internal angle of the triangle is less than ninety (90) degrees.

19. The cleaning apparatus as recited in claim 10, wherein the air knife includes an upper nozzle and a lower nozzle which a vertical gap therebetween substantial larger or equal to a vertical distance between the auxiliary roller set and the primary roller set.

20. The cleaning apparatus as recited in claim 10, wherein the cleaning apparatus further includes a pair of fenders arranged on sides of the transaxles.
